(19) United States
(12) Patent Application Publication
(10) Pub. No.: US 2020/0193698 A1
(43) Pub. Date: Jun. 18, 2020

(54) ROBOTIC 3D SCANNING SYSTEMS AND SCANNING METHODS

(71) Applicant: Guangdong Kang Yun Technologies Limited, Guangzhou City (CN)

(72) Inventor: Seng Fook Lee, Guangzhou City (CN)

(21) Appl. No.: 16/616,183

(22) PCT Filed: Jun. 15, 2018
(86) PCT No.: PCT/CN2018/091581

§ 371 Date: Nov. 22, 2019

Related U.S. Application Data
(60) Provisional application No. 62/584,136, filed on Nov. 10, 2017.

(51) Int. Cl. G06T 17/00; G06T 15/04

(52) U.S. Cl. CPC G06T 17/00; G06T 2210/56; G06T 15/04

(57) ABSTRACT

A robotic three-dimensional (3D) scanning system for scanning of an object is provided. The robotic 3D scanning system includes: a database configured to store a plurality of pre-stored 3D scanned images; one or more cameras configured to take at least one image shot of the object for scanning; a depth sensor configured to create a point cloud of the object; and a processor configured to generate a 3D scanned image by comparing the at least one image shot with the plurality of pre-stored 3D scanned images in the database, using a matched image for generating a 3D scanned image when a match corresponding to the at least one image shot is available in the database, else merging and processing the point cloud with the at least one image shot for generating a 3D scanned image. The 3D scanned image may be stored in the database.

### CROSS REFERENCE TO RELATED APPLICATIONS

This application is a national stage application under 35 U.S.C. 371 of PCT Application No. PCT/CN2018/091581, filed 15 Jun. 2018, which PCT application claimed the benefit of U.S. Provisional Patent Application No. 62/584,136, filed 10 Nov. 2017, the entire disclosure of each of which are hereby incorporated herein by reference.

### TECHNICAL FIELD

The presently disclosed embodiments relate to the field of imaging and scanning technologies. More specifically, embodiments of the present disclosure relate to robotic three-dimensional (3D) scanning systems and automatic 3D scanning methods for generating 3D scanned images of a plurality of objects and/or environment by comparing with a plurality of pre-stored 3D scanned images.

### BACKGROUND

A three-dimensional (3D) scanner may be a device capable of analysing environment or a real-world object for collecting data about its shape and appearance, for example, colour, height, length width, and so forth. The collected data may be used to construct digital three-dimensional models. Usually, 3D laser scanners create “point clouds” of data from a surface of an object. Further, in the 3D laser scanning, physical object's exact size and shape is captured and stored as a digital 3-dimensional representation. The digital 3-dimensional representation may be used for further computation. The 3D laser scanners work by measuring a horizontal angle by sending a laser beam all over the field of view. Whenever the laser beam hits a reflective surface, it is reflected back into the direction of the 3D laser scanner.

The existing 3D scanners or systems suffer from multiple limitations. For example, a higher number of pictures need to be taken by a user for making a 360-degree view. Also the 3D scanners take more time for taking or capturing pictures. Further, a stitching time is more for combining the more number of pictures (or images). Similarly, the processing time for processing the more number of pictures increases. Further, because of more number of pictures, the final scanned picture becomes heavier in size and may require more storage space. In addition, the user may have to take shots manually that may increase the user's effort for scanning of the objects and environment. Further, the present 3D scanner does not provide real-time merging of point clouds and image shots. Also a final product is presented to the user, there is no way to show intermediate process of rendering to the user. Further, in existing systems, some processor in a lab does the rendering of the object.

### SUMMARY

In light of above discussion, there exists need for better techniques for automatic scanning and primarily three-dimensional (3D) scanning of objects without any manual intervention. The present disclosure provides robotic systems and automatic scanning methods for 3D scanning of objects including at least one of symmetrical and unsymmetrical objects.

An objective of the present disclosure is to provide a handheld robotic 3D scanning system for scanning a plurality of objects/products.

An objective of the present disclosure is to provide robotic 3D scanning systems and automatic scanning methods for self reviewing or self monitoring a quality of rendering and 3D scanning of an object in real-time so that one or more measures may be taken in real-time for enhancing a quality of the scanning/rendering in real-time.

Another objective of the present disclosure is to provide robotic 3D scanning systems and automatic-scanning methods for real-time rendering of objects by comparing with pre-stored 3D scanned images.

Another objective of the present disclosure is to provide a handheld scanning system configured to self-review or self-check a quality of rendering and scanning of an object in real-time.

Another objective of the present disclosure is to provide robotic 3D scanning systems and automatic scanning methods for three-dimensional scanning and rendering of objects in real-time based on self reviewing or self monitoring of rendering and scanning quality in real-time. The one or more steps like re-scanning of the object may be done for enhancing a quality of the rendering of the object based in real-time. Further, the image shot is compared with pre-stored data for saving time.

A yet another objective of the present disclosure is to provide robotic 3D scanning systems and automatic scanning methods for generating a high quality 3D scanned images of an object in less time.

Another objective of the present disclosure is to provide a real-time self-learning module for 3D scanning system for 3D scanning of a plurality of an object. The self-learning module enables self-reviewing or self-monitoring to check an extent and quality of scanning in real-time while an image shot is being rendered with a point cloud of the object.

Another objective of the present disclosure is to provide robotic 3D scanning systems for utilizing pre-stored image data for generating 3D scanned images of an object.

Another objective of the present disclosure is to provide robotic 3D scanning system having a database storing a number of 3D scanned images.

A yet another objective of the present disclosure is to provide a robotic 3D object scanning system having a depth sensor or an RGBD camera/sensor for creating a point cloud of the object. The point cloud may be merged and processed with a scanned image for creating a real-time rendering of the object by finding a match in the pre-stored images stored in the database. In some embodiments, the depth sensor may be at least one of a RGB-D camera, a Time-of-Flight (ToF) camera, a ranging camera, and a Flash LIDAR.

Another objective of the present disclosure is to provide a robotic 3D scanning system configured to save time in 3D scanning of objects by using pre-stored 3D scanned image data.

The present disclosure also provides robotic 3D scanning systems and methods for generating a good quality 3D model including scanned images of object(s) with a less number of images or shots for completing a 360-degree view of the object.

An embodiment of the present disclosure provides a robotic three-dimensional (3D) scanning system for scanning of an object, comprising: a database configured to store a plurality of pre-stored 3D scanned images; one or more cameras configured to take at least one image shot of the object for scanning; a depth sensor configured to create a point cloud of the object; and a processor configured to generate a 3D scanned image by comparing the at least one image shot with the plurality of pre-stored 3D scanned images in the database, when a match corresponding to the at least one image shot is available in the database a matched 3D scanned image is used for generating a 3D scanned image of the object, else a 3D scanned image of the object is generated by merging and processing the point cloud with the at least one image shot. The 3D scanned image may be stored in the database for future use.

According to an aspect of the present disclosure, the point cloud is rendered with one or more image shots for creating a complete and efficient 3D image of the object.

Another embodiment of the present disclosure provides three-dimensional (3D) scanning system for 3D scanning of an object, comprising: a robotic scanner comprising: one or more cameras configured to take at least one image shot of the object; a depth sensor configured to create a point cloud of the object; and a first transceiver configured to send the point cloud and the at least one image shot for further processing to a cloud network. The system also includes a rendering module in the cloud network, comprising: a second transceiver configured to receive the point cloud and at least one image shot from the robotic scanner via the cloud network; a database configured to store a plurality of 3D scanned images; and a processor configured to generate a 3D scanned image by comparing the at least one image shot with the plurality of pre-stored 3D scanned images in the database, using a matched image for generating a 3D scanned image when a match corresponding to the at least one image shot is available in the database, else merging and processing the point cloud with the at least one image shot for generating a 3D scanned image, wherein the 3D scanned image is stored in the database, further wherein the second transceiver sends the 3D scanned image of the object to the robotic scanner.

Another embodiment of the present disclosure provides a method for automatic three-dimensional (3D) scanning of an object, comprising: taking at least one image shot of the object for scanning; creating a point cloud of the object; generating a 3D scanned image by comparing the at least one image shot with the plurality of pre-stored 3D scanned images in a database, using a matched image for generating the 3D scanned image when a match corresponding to the at least one image shot is available in the database, else merging and processing the point cloud with the at least one image shot for generating the 3D scanned image; and storing the 3D scanned image is stored in the database, wherein the database comprises a plurality of pre-stored 3D scanned images.

A further embodiment of the present disclosure provides an automatic method for 3D scanning of an object. The method at a robotic scanner comprises: taking, by one or more cameras, at least one image shot of the object for scanning; creating, by a depth sensor, a point cloud of the object; and sending, by a first transceiver, the point cloud and the at least one image shot for further processing to a cloud network. The method at a rendering module in the cloud network includes storing a plurality of 3D scanned images; receiving, by a second transceiver, the point cloud and one or more image shots from the scanner via the cloud network; and generating, by a processor, a 3D scanned image by comparing the at least one image shot with the plurality of pre-stored 3D scanned images in the database, using a matched image for generating a 3D scanned image when a match corresponding to the at least one image shot is available in the database, else merging and processing the point cloud with the at least one image shot for generating a 3D scanned image, wherein the 3D scanned image is stored in the database, further wherein the second transceiver sends the 3D scanned image of the object to the robotic scanner.

According to an aspect of the present disclosure, the depth sensor comprises at least one of a RGB-D camera, a Time-of-Flight (ToF) camera, a ranging camera, and a Flash LIDAR.

In some embodiments, the database may be located in a cloud network.

According to another aspect of the present disclosure, the robotic scanner is a handheld device.

According to another aspect of the present disclosure, the one or more cameras takes the one or more shots of the object one by one based on the laser center co-ordinate and a relative width of the first shot.

According to a further aspect of the present disclosure, the robotic scanner further comprises a laser light configured to indicate the exact position by using a green color for taking the at least one shot.

According to an aspect of the present disclosure, a robotic 3D scanning system takes a first shot (i.e. Ni) of an object and based on that, a laser center co-ordinate may be defined for the object.

According to an aspect of the present disclosure, a robotic 3D scanning system comprises a database including a number of 3D scanned images. The pre-stored images are used while rendering of an object for generating a 3D scanned image. Using pre-stored image may save processing time.

According to an aspect of the present disclosure, for the second shot, the robotic 3D scanning system may provide a feedback about an exact position for taking the second shot (i.e. N2) and so on (i.e. N3, N4, and so forth). The robotic 3D scanning system may self move to the exact position and take the second shot and so on (i.e. the N2, N3, N4, and so on).

According to an aspect of the present disclosure, the robotic 3D scanning system may need to take few shots for completing a 360-degree view or a 3D view of the object or an environment.

According to an aspect of the present disclosure, the matching of a 3D scanned image may be performed by using a suitable technique comprising, but are not limited to, a machine vision matching, artificial intelligence matching, pattern matching, and so forth. In some embodiments, only scanned part is matched for finding a 3D scanned image from the database.

According to an aspect of the present disclosure, the matching of the image shots is done base don one or more parameters comprising, but are not limited to, shapes, textures, colors, shading, geometric shapes, and so forth.

According to another aspect of the present disclosure, the laser center co-ordinate is kept un-disturbed while taking the plurality of shots of the object.

According to another aspect of the present disclosure, the robotic 3D scanning system on a real-time basis processes the taken shots. In some embodiments, the taken shots and images may be sent to a processor in a cloud network for further processing in a real-time.

According to an aspect of the preset disclosure, the processor of the robotic 3D scanning system may define a laser center co-ordinate for the object from a first shot of the plurality of shots, wherein the processor defines the exact position for taking the subsequent shot without disturbing the laser center co-ordinate for the object based on a feedback.

According to another aspect of the present disclosure, the robotic 3D scanning system further includes a feedback module configured to provide at least one of a visual and an audio feedbacks about the exact position by using a green color for taking at least one shot.

According to another aspect of the present disclosure, the plurality of shots is taken one by one with a time interval between two subsequent shots.

According to another aspect of the present disclosure, the robotic 3D scanning system further includes a motion-controlling module comprising at least one wheel configured to enable a movement from a current position to an exact position for taking the at least one image shot of the object one by one.

According to another aspect of the present disclosure, the robotic 3D scanning system further includes a self-learning module configured to self-review and self-check a quality of the scanning process and of the rendered map.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIGS. 1A-1B illustrates exemplary environments where various embodiments of the present disclosure may function;

FIG. 2 is a block diagrams illustrating system elements of an exemplary robotic three-dimensional (3D) scanning system, in accordance with various embodiments of the present disclosure;

FIGS. 3A-3C illustrate a flowchart of a method for automatic three-dimensional (3D) scanning of an object, in accordance with an embodiment of the present disclosure; and

FIGS. 4A-4B illustrate a flowchart of a method for automatic three-dimensional (3D) scanning of an object by using pre-stored 3D scanned images, in accordance with an embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). To facilitate understanding, like reference numerals have been used, where possible, to designate like elements common to the figures.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference throughout this specification to “a select embodiment”, “one embodiment” or “an embodiment” means that a particular feature, structure, or characteristic described in connection with the embodiment is included in at least one embodiment of the disclosed subject matter. Thus, appearances of the phrases “a select embodiment” “in one embodiment” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

The following detailed description should be read with reference to the drawings, in which similar elements in different drawings are identified with the same reference numbers. The drawings, which are not necessarily to scale, depict illustrative embodiments and are not intended to limit the scope of the disclosure.

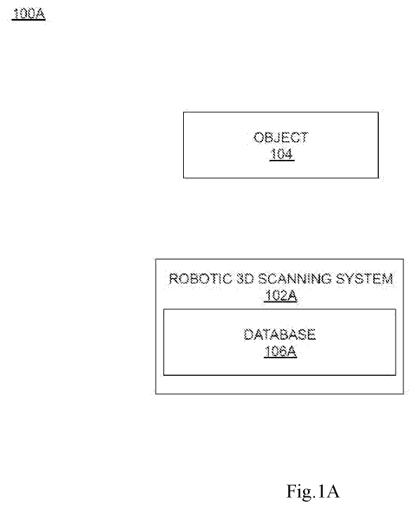

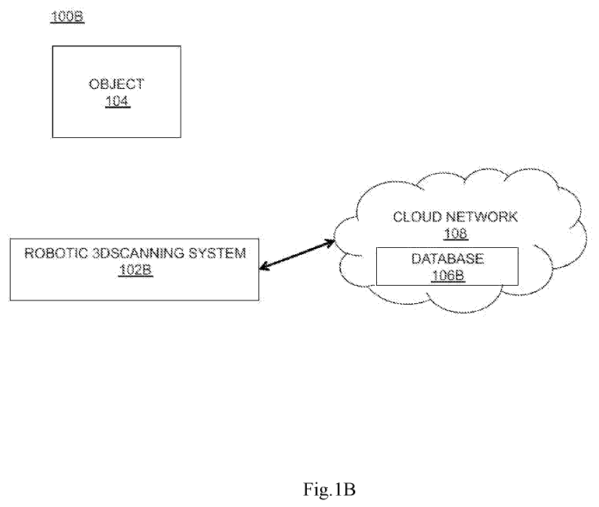

FIGS. 1A-1B illustrates an exemplary environments 100A-100B, respectively, where various embodiments of the present disclosure may function. As shown in FIG. 1A, the environment 100 primarily includes a robotic 3D scanning system 102A for 3D scanning of a plurality of objects such as, an object 104. The object 104 may be a symmetrical object and an unsymmetrical object having uneven surface. Though only one object 104 is shown, but a person ordinarily skilled in the art will appreciate that the environment 100 may include more than one object 104. The robotic 3D scanning system 102A also includes a database 106A for storing a number of 3D scanned images that may be used/searched while processing of one or more image shots. In some embodiments, the robotic 3D scanning system 102A may be a device or a combination of multiple devices, configured to analyse a real-world object or an environment and may collect/capture data about its shape and appearance, for example, colour, height, length width, and so forth. The robotic 3D scanning system 102A may use the collected data to construct a digital three-dimensional model.

Further, the robotic 3D scanning system 102A is configured to process of point clouds and image shots for rendering of objects. The robotic 3D scanning system 102A may store a number of 3D scanned images. The robotic 3D scanning system 102A may search for a matching 3D scanned image corresponding to an image shot in the pre-stored 3D scanned images in the database 106A and may use the same for generating a 3D scanned image.

In some embodiments, the robotic 3D scanning system 102A is configured to determine an exact position for capturing one or more image shots of an object. The robotic 3D scanning system 102A may be a self-moving device comprising at least one wheel. The robotic 3D scanning system 102A is capable of moving from a current position to the exact position. The robotic 3D scanning system 102A comprising a depth sensor such as an RGBD camera is configured to create a point map of the object 104. The point cloud may be a set of data points in some coordinate system. Usually, in a three-dimensional coordinate system, these points may be defined by X, Y, and Z coordinates, and may intend to represent an external surface of the object 104.

Further, the robotic 3D scanning system 102A is configured to capture one or more image shots of the object 104 for generating a 3D model including at least one image of the object 104. In some embodiments, the robotic 3D scanning system 102A is configured to capture less number of images of the object 104 for completing a 360-degree view of the object 104. Further, in some embodiments, the robotic 3D scanning system 102A may be configured to generate 3D scanned models and images of the object 104 by processing the point cloud with the image shots.

Further, the robotic 3D scanning system 102A may define a laser center co-ordinate for the object 104 from a first shot of the shots. Further, the robotic 3D scanning system 102A may define the exact position for taking the subsequent shot without disturbing the laser center co-ordinate for the object. The exact position for taking the subsequent shot is defined without disturbing the laser center co-ordinate for the object 104. Further, the robotic 3D scanning system 102A is configured to define a new position co-ordinate of the based on the laser center co-ordinate and the relative width of the shot. The robotic 3D scanning system 102A may be configured to self-move to the exact position to take the one or more shots of the object 104 one by one based on an indication or the feedback. In some embodiments, the robotic 3D scanning system 102A may take subsequent shots of the object 104 one by one based on the laser center co-ordinate and a relative width of a first shot of the shots. Further, the subsequent one or more shots may be taken one by one after the first shot. For each of the one or more, the robotic 3D scanning system 102A may point a green laser light on an exact position or may provide feedback about the exact position to take a shot.

Further, the robotic 3D scanning system 102A may be configured to process the image shots in real-time. First the robotic 3D scanning system 102A may search for a matching 3D scanned image corresponding to the one or more image shots in the pre-stored 3D scanned images of the database 106A based on one or more parameters. The matching may be performed based on the one or more parameters including, but are not limited to, geometric, shapes, textures, colors, shading, and so forth. Further, the matching may be performed using various techniques comprising machine vision matching, and artificial intelligence (AI) matching, and so forth. And if a matching 3D scanned image is found then the robotic 3D scanning system 102A may use the same for generating the complete 3D scanned image for the object 104. This may save the time required for generating the 3D model or 3D scanned image. On the other hand when no matching 3D scanned image is found, then the robotic 3D scanning system 102A may merge and process the multiple image shots with the point cloud of the object 104 to generate at least one high quality 3D scanned image of the object 104. The robotic 3D scanning system 102A may merge and process the point cloud and the one or more shots for rendering of the object 104. The robotic 3D scanning system 102A may self-review and monitor a quality of a rendered map of the object 104. If the quality is not good, the robotic 3D scanning system 102A may take one or more measures like re-scanning the object 104.

The robotic 3D scanning system 102A may include wheels for self-moving to the exact position. Further, the robotic 3D scanning system 102A may automatically stop at the exact position for taking the shots. Further, the robotic 3D scanning system 102A may include one more arms including at least one camera for clicking the images of the object 104. The arms may enable the cameras to capture shots precisely from different angles. In some embodiments, a user (not shown) may control movement of the robotic 3D scanning system 102A via a remote controlling device or a mobile device like a phone.

In some embodiments, the robotic 3D scanning system 102A doesn't include the database 106A and a database 106B may be located in a cloud network 108 as shown in FIG. 1B. In such embodiments, the database 106B may be present in the cloud network 108. A robotic 3D scanning system 102B may access the database 106B for searching for a matching 3D scanned image corresponding to one or more image shots for processing.

After receiving the point cloud and the image shots from the robotic 3D scanning system 102B, the robotic 3D scanning system 102B may be configured to process the image shots in real-time. First the robotic 3D scanning system 102B may search for a matching 3D scanned image corresponding to the one or more image shots in the pre-stored 3D scanned images in the database 106B based on one or more parameters. The matching may be performed based on the one or more parameters including, but are not limited to, geometric, shapes, textures, colors, shading, and so forth. Further, the matching may be performed using various techniques comprising machine vision matching, and artificial intelligence (AI) matching, and so forth. And if a matching 3D scanned image is found then the robotic 3D scanning system 102B may use the same for generating the complete 3D scanned image for the object 104. This may save the time required for generating the 3D model or 3D scanned image. On the other hand when no matching 3D scanned image is found, then the robotic 3D scanning system 102B may merge and process the multiple image shots with the point cloud of the object 104 to generate at least one high quality 3D scanned image of the object 104. In some embodiments, the robotic 3D scanning system 102B may send a feedback regarding a quality of rendering and scanning to the robotic 3D scanning system 102B. The robotic 3D scanning system 102B may re-scan or re-take more image shots comprising images of missing parts of the object 104 and send the same to the robotic 3D scanning system 102B. The robotic 3D scanning system 102B may again check for a matching 3D scanned image corresponding to the new image shot(s) covering a missing part of the object 104. In some embodiments, the robotic 3D scanning system 102B may check the quality of rendering and if quality is ok then the robotic 3D scanning system 102B may approve a rendered map and generate a good quality 3D scanned image. The robotic 3D scanning system 102B may also save the 3D scanned image in the database 106B. The 3D scanned image may be stored in the database 106B in the cloud network 108 and/or in the database 106B at the robotic 3D scanning system 102B.

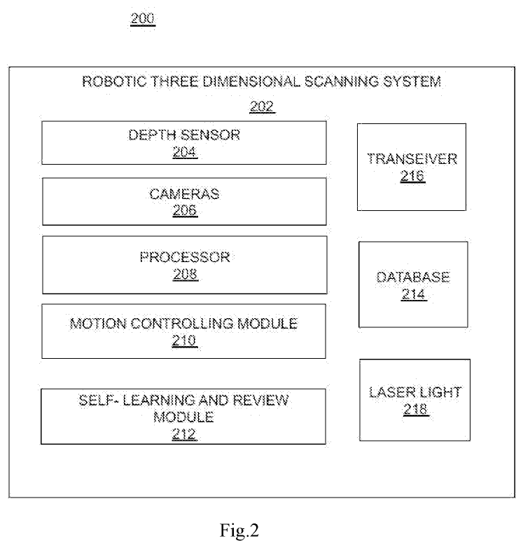

FIG. 2 is a block diagram 200 illustrating system elements of an exemplary robotic 3D scanning system 202, in accordance with various embodiments of the present disclosure. As shown the robotic 3D scanning system 202 primarily including a depth sensor 204, one or more cameras 206, a processor 208, a motion controlling module 210, a self-learning module 212, a database 214, a transceiver 216, and a laser light 218. As discussed with reference to FIGS. 1A-1B, the robotic 3D scanning system 202 may be configured to generate 3D scanned images of the object 104. In some embodiments, the robotic 3D scanning system 202 may include only one of the cameras 206.

The depth sensor 204 is configured to create a point cloud of an object, such as the object 104 of FIG. 1. The point cloud may be a set of data points in a coordinate system. In a three-dimensional coordinate system, these points may be defined by X, Y, and Z coordinates, and may intend to represent an external surface of the object 104. The depth sensor 204 may be at least one of a RGB-D camera, a Time-of-Flight (ToF) camera, a ranging camera, and a Flash LIDAR.

In some embodiments, the processor 208 may be configured to identify an exact position for taking one or more shots of the object 104. In some embodiments, the exact position may be as specified by the laser light 218 or a feedback module (not shown) of the robotic 3D scanning system 202. For example, the laser light 218 may point a green light on the exact position for indicating the position for taking next shot.

The motion-controlling module 210 may move the robotic 3D scanning system 202 from a position to the exact position. The motion-controlling module 210 may include at least one wheel for enabling movement of the robotic 3D scanning system 202 from one position to other. In some embodiments, the motion-controlling module 210 includes one or more arms comprising the cameras 206 for enabling the cameras to take image shots of the object 104 from different angles for covering the object 104 completely. In some embodiment, the motion-controlling module 210 comprises at least one wheel is configured to enable a movement of the robotic 3D scanning system 202 from a current position to the exact position for taking the one or more image shots of the object 104 one by one. The motion-controlling module 210 may stop the robotic 3D scanning system 202 at the exact position.

The cameras 206 may be configured to take one or more image shots of the object 104. Further, the one or more cameras 206 may be configured to capture the one or more image shots of the object 104 one by one based on the exact position. In some embodiments, the cameras 206 may take a first shot and the one or more image shots of the object 104 based on a laser center coordinate and a relative width of the first shot such that the laser center coordinate remains undisturbed while taking the plurality of shots of the object 104. Further, the 3D scanning system 202 includes the laser light 218 configured to indicate an exact position for taking a shot by pointing a specific colour such as, but not limited to, a green colour, light to the exact position.

Further, the processor 208 may be configured to process the image shots and the point cloud in real-time. In some embodiments, the robotic 3D scanning system 102A may search for a matching 3D scanned image corresponding to the one or more image shots in the pre-stored 3D scanned images in the database 214 based on one or more parameters. The matching may be performed based on the one or more parameters including, but are not limited to, geometric, shapes, textures, colors, shading, and so forth. Further, the matching may be performed using various techniques comprising machine vision matching, and artificial intelligence (AI) matching, and so forth. And if a matching 3D scanned image is found then the processor 208 may use the same for generating the complete 3D scanned image for the object 104. This may save the processing time required for generating the 3D model or a high quality 3D scanned image of the object. On the other hand when no matching 3D scanned image is found, then the processor 208 may merge and process the one or more image shots with the point cloud of the object 104 to generate at least one high quality 3D scanned image of the object 104. The processor 208 may also be configured to render the object 104 in real-time by merging and processing the point cloud with the one or more image shots for generating the high quality 3D scanned image. The processor 208 merges and processes the point cloud with the at least one image shot for generating a rendered map.

In some embodiments, the self-learning module 212 may review or monitor/check a quality of the scanning or rendering of the object 104 or of a rendered map of the object 104 in real time. Further, when the quality of the scanning/rendered map is not good, then the self-learning module 212 may instruct the cameras 206 to capture at least one image shot and may instruct the depth sensor 204 to create at least one point cloud until for rendering of the object a good quality rendered object comprising a high quality 3D scanned object is generated. The processor 208 may repeat the process of finding a match and processing of the image shots for generating high quality 3D scanned image(s).

The database 214 may be configured to store the 3D scanned images, rendered images, rendered maps, instructions for scanning and rendering of the object 104, and 3D models. In some embodiments, the database 214 may be a memory. The processor 208 searches in the database 214 for finding a matching 3D scanned image corresponding to the image shot.

The transceiver 216 may be configured to send and receive data, such as image shots, point clouds etc., to/from other devices via a network including a wireless network and a wired network.

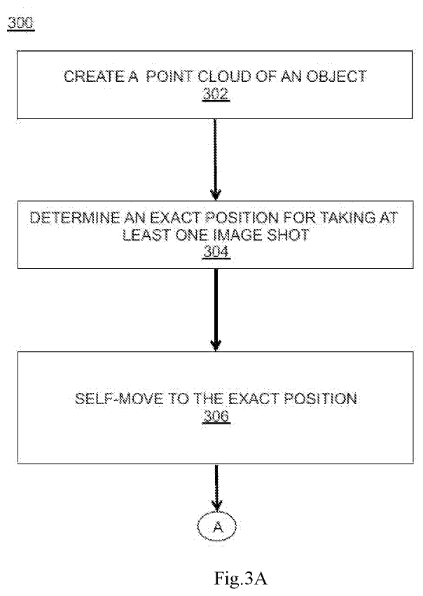

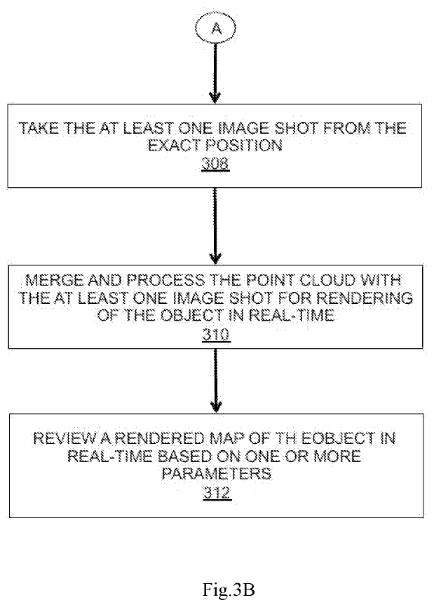

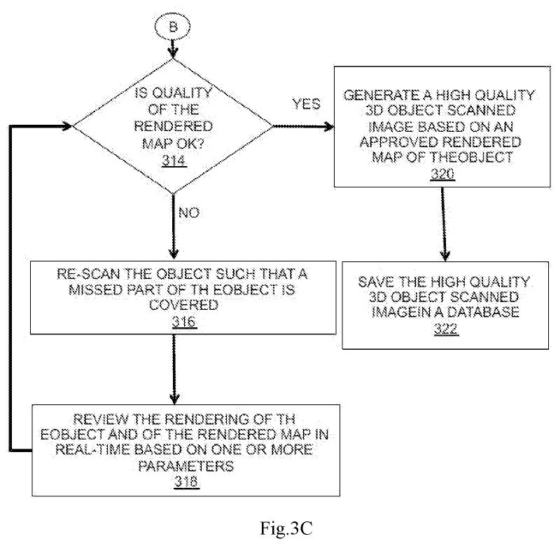

FIGS. 3A-3C illustrate a flowchart of a method 300 for automatic three-dimensional (3D) scanning of an object and saving a scanned image of the object in a database of a robotic 3D scanning system, in accordance with an embodiment of the present disclosure.

At step 302, a depth sensor of a robotic 3D scanning system creates a point cloud of the object. At step 304, an exact position for taking at least one image shot is determined. Then at step 306, the robotic 3D scanning system moves from a current position to the exact position. Then at step 308, one or more cameras of the robotic 3D scanning system takes the at least one image shot of the object from the exact position. The object may be a symmetrical object or an unsymmetrical object. The object can be a person, product, or an environment.

Then at step 310, the point cloud and the at least one image shot are merged and processed for generating a rendered map. At step 312, the rendered map is self-reviewed and monitored by a self-learning module of the robotic 3D scanning system for checking a quality of the rendered map. Then at step 314, it is checked if the quality of the rendered map is ok or not. If No at step 314 then process control goes to step 316 else a step 320 is executed. At step 316, the object is re-scanned by the one or more cameras such that a missed part of the object is scanned properly. Thereafter at step the rendering of the object is again reviewed in real-time based on one or more parameters such as, but not limited to, machine vision, stitching extent, texture extent, and so forth.

If yes at step 314, then at step 320, a high quality 3D scanned image of the object is generated from the approved rendered map of the object. In some embodiments, a processor may generate the high quality 3D scanned image of the object. Thereafter at step 322, the 3D scanned image is stored in the database of the robotic 3D scanning system. In some embodiments, the 3D scanned image may be stored in a database remotely located in a cloud network or on any other device in the network.

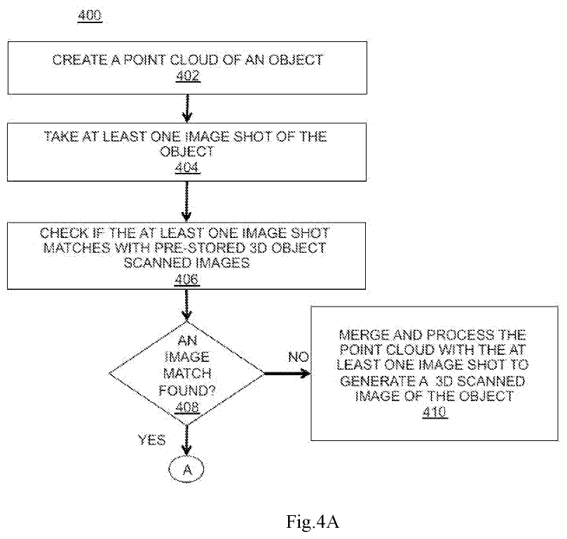

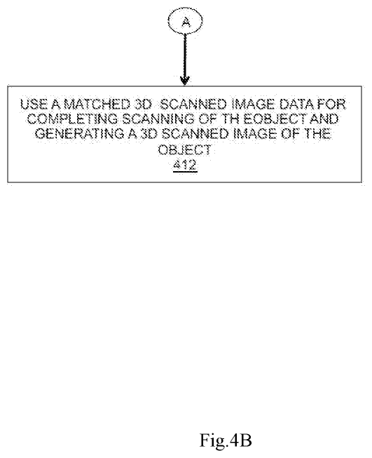

FIGS. 4A-4C illustrate a flowchart of a method 400 for automatic three-dimensional (3D) scanning of an object by searching in a database of a robotic 3D scanning system, in accordance with an embodiment of the present disclosure.

At step 402, a depth sensor of the robotic 3D scanning system creates a point cloud. Then at step 404, a camera of the robotic 3D scanning system takes at least one image shot. At step 406, at least one image shot is compared with a plurality of pre-stored image shots of a database for finding a matching 3D scanned image corresponding to the at least one image shot. Then at step 408, is it checked if a matching 3D scanned image corresponding to the at least one image is found or not. If NO at step 408, then process control goes to step 410, else process continues to step 412.

At step 410, a processor of the robotic 3D scanning system merges and processes the point cloud with the at least one image shot for rendering of the object and for generating a high quality 3D scanned image of the object.

At step 412, the matching 3D scanned image is used for generating a high quality 3D scanned image of the object. This way the processor may not have to process or render the image shot with the point cloud again and can directly use the ready made scanned image for whole or a portion of the object.

The present disclosure provides a hand-held robotic 3D scanning system for scanning of objects.

According to an aspect of the present disclosure, a robotic 3D scanning system comprises a database including a number of 3D scanned images. The pre-stored images are used while rendering of an object for generating a 3D scanned image. Using pre-stored image may save processing time.

The present disclosure enables storing of a final 3D scanned image of the object on a local database or on a remote database. The local database may be located in a robotic 3D scanning system. The remote database may be located in a cloud network.

The system disclosed in the present disclosure also provides better scanning of the objects in less time. Further, the system provides better stitching while processing of the point clouds and image shots. The system results in 100% mapping of the object, which in turn results in good quality scanned image(s) of the object without any missing parts.

The system disclosed in the present disclosure produces scanned images with less error rate and provides 3D scanned images in less time.

Embodiments of the disclosure are also described above with reference to flowchart illustrations and/or block diagrams of methods and systems. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flowchart and/or block diagram block or blocks.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

What is claimed is:

1. A robotic three-dimensional (3D) scanning system for scanning of an object, comprising:
a database configured to store a plurality of pre-stored 3D scanned images; one or more cameras configured to take at least one image shot of the object for scanning;
a depth sensor configured to create a point cloud of the object; and
a processor configured to generate a 3D scanned image by comparing the at least one image shot with the plurality of pre-stored 3D scanned images in the database, using a matched image for generating a 3D scanned image when a match corresponding to the at least one image shot is available in the database, else merging and processing the point cloud with the at least one image shot for generating a 3D scanned image;
wherein the 3D scanned image is stored in the database.

2. The robotic three-dimensional scanning system of claim 1 further comprising a motion-controlling module comprising at least one wheel configured to enable a movement from a current position to an exact position for taking the at least one image shot of the object one by one.

3. The robotic three-dimensional scanning system of claim 1, wherein the depth sensor comprises at least one of a RGB-D camera, a Time-of-Flight (ToF) camera, a ranging camera, and a Flash LIDAR.

4. The robotic three-dimensional scanning system of claim 1 further comprising a laser light configured to indicate the exact position by using a green color for taking at least one shot.

5. The robotic three-dimensional scanning system of claim 1 further comprising a feedback module configured to provide at least one of a visual and an audio feedbacks about the exact position by using a green color for taking at least one shot.

6. A three-dimensional (3D) scanning system for 3D scanning of an object, comprising:
a robotic scanner comprising:
one or more cameras configured to take at least one image shot of the object;
a depth sensor configured to create a point cloud of the object; and
a first transceiver configured to send the point cloud and the at least one image shot for further processing to a cloud network; and
a rendering module in the cloud network, comprising:
a second transceiver configured to receive the point cloud and at least one image shot from the robotic scanner via the cloud network;
a database configured to store a plurality of 3D scanned images; and
a processor configured to generate a 3D scanned image by comparing the at least one image shot with the plurality of pre-stored 3D scanned images in the database, using a matched image for generating a 3D scanned image when a match corresponding to the at least one image shot is available in the database, else merging and processing the point cloud with the at least one image shot for generating a 3D scanned image, wherein the 3D scanned image is stored in the database, further wherein the second transceiver sends the 3D scanned image of the object to the robotic scanner.

7. The three-dimensional scanning system of claim 6, wherein the depth sensor comprises at least one of a RGB-D camera, a Time-of-Flight (ToF) camera, a ranging camera, and a Flash LIDAR.

8. The three-dimensional scanning system of claim 6, wherein the robotic scanner is a handheld device.

9. The three-dimensional scanning system of claim 6, wherein the robotic scanner further comprises a laser light configured to indicate the exact position by using a green color for taking the at least one shot.

10. The three-dimensional scanning system of claim 6 wherein the robotic sensor further comprises a motion controlling module configured to move the robotic scanner from a current position to the exact position for taking the at least one image shot of the object one by one

11. A method for automatic three-dimensional (3D) scanning of an object, comprising:
taking at least one image shot of the object for scanning;
creating a point cloud of the object;
generating a 3D scanned image by comparing the at least one image shot with the plurality of pre-stored 3D scanned images in a database, using a matched image for generating the 3D scanned image when a match corresponding to the at least one image shot is available in the database, else merging and processing the point cloud with the at least one image shot for generating the 3D scanned image; and
storing the 3D scanned image is stored in the database, wherein the database comprises a plurality of pre-stored 3D scanned images.

12. The method of claim 12, wherein the depth sensor comprises at least one of a RGB-D camera, a Time-of-Flight (ToF) camera, a ranging camera, and a Flash LIDAR.

13.-15. (canceled)
